(19) United States
(12) Patent Application Publication
(10) Pub. No.: US 2018/0097577 A1
(43) Pub. Date: Apr. 5, 2018

(54) ETHERNET DISTRIBUTED PASSIVE OPTICAL NETWORKING FOR SUBSEA SYSTEMS

(71) Applicant: GE Oil & Gas UK Limited, Bristol (GB)

(72) Inventor: Matthew Edmund STONE, Nailsea, Bristol (GB)

(21) Appl. No.: 15/562,487

(22) PCT Filed: Mar. 29, 2016
(86) PCT No.: PCT/EP2016/056811

§ 371 Date: Sep. 28, 2017

(30) Foreign Application Priority Data
Mar. 30, 2015 (GB) 1505439.8

(51) Int. Cl. H04J 14/02; H04B 10/25

(52) U.S. Cl. CPC H04J 14/023; E21B 47/123; H04B 10/25

(57) ABSTRACT

A method for routing communications signals at an underwater hydrocarbon extraction facility comprising: providing a routing module at an underwater location, the routing module comprising a passive wavelength division demultiplexer; sending wavelength division multiplexed communications signals to the routing module from a surface location via an input optical fibre; demultiplexing wavelength division multiplexed communications signals using the passive wavelength division demultiplexer to produce a plurality of demultiplexed output communications signals; and outputting the output demultiplexed communications signals via respective output optical fibres.

### BACKGROUND

This invention relates to a routing module for an underwater hydrocarbon extraction facility, an underwater hydrocarbon extraction facility communications system, a hydrocarbon extraction facility communications system and a method for routing communications signals at an underwater hydrocarbon extraction facility.

Underwater hydrocarbon production facilities, e.g. subsea oil/gas extraction facilities, are typically linked to a surface (topside) location via an “umbilical” cable which carries both power and communications lines. Communications lines may for example comprise copper or optical fibre lines, with optical systems becoming the norm. The subsea end of the umbilical is received at a “power and communications distribution module” (PCDM) which typically routes the communications signals to a number of separate subsea modules. Umbilical cables are very expensive components, and to reduce the number of communications lines that need to be included, the transmitted communications signals are generally multiplexed so that a number of individual communications channels can be carried by a single line. Communications subsea, i.e. between the PCDM and the individual trees, may again comprise optical or copper lines. A system which uses optical fibre for communications both within the umbilical and subsea is known as an “optical-optical” system, i.e. the PCDM receives communications signals from the umbilical's optical fibre, performs some demultiplexing and then routes the demultiplexed communications signals to the appropriate module via respective optical fibres.

Traditional subsea optical-to-optical distribution and routing systems utilise an active routing technology, typically a Layer 3 managed Ethernet switch connected to optical media conversion modules. Such an active system is schematically shown in FIG. 1. Here, a master station 1 is located topside, and separate power (2) and communications (3) lines are carried by an umbilical (not shown), and received at a subsea PCDM 4. The PCDM 4 comprises a power distribution unit 5 which receives the power line 2, and a communications distribution unit 6, which receives the communications line 3. As shown, there are three separate control modules 7, 8, 9 which are associated with respective production units (e.g. “Xmas trees”), and so it is necessary for the power and communications distribution units 5, 6 to provide power and the correct communications signals to each control module. The communications distribution unit 6 comprises an Ethernet Layer 3 switch, as shown in the enlarged and schematic FIG. 2, which actively routes the received communications signals to the correct control module. Since the routing is active, it is necessary for power to be supplied to the communications distribution unit 6, and as shown this is tapped directly from the umbilical power line, although it could be provided via the power distribution unit 5. The power distribution is well-known in the art and so is not described in any detail.

Such distribution systems work. However, the use of active routing requires additional copper to be used, and power to be provided to operate the active switch.

It is an aim of the present invention to overcome these problems, and enable copper-free communications routing and distribution for such underwater systems. This is of particular benefit for long-offset systems.

### BRIEF DESCRIPTION OF THE INVENTION

This aim is achieved by using wavelength division multiplexing to combine communications signals onto an optical line, and using a passive wavelength division demultiplexer in the underwater router module.

By utilising wavelength division multiplexing passive optical technology, it is possible to passively route optical communications signals without any additional power requirements. High-level addressing can be used to route the signals as required. Latency in the system is reduced (there is no processing in the loop), and bit-error rates are improved (again because there is no mid-line processing which can introduce errors).

It should be noted that in the description below, reference is made to multiplexing/demultiplexing and multiplexers/demultiplexers. In fact, the same components can often be used for both multiplexing and demultiplexing, the only difference being the direction of the signal transfer involved. This becomes important when considering that usually bi-directional communication is required between the surface and underwater location. However, for simplicity, the majority of the following discussion concerns communications signals sent from the surface to the underwater location, and the terms multiplexer/demultiplexer are used accordingly.

According to an embodiment of the present invention there is provided a routing module for an underwater hydrocarbon extraction facility, configured to receive a multiplexed communications signal via an input optical fibre and output demultiplexed communications signals to a plurality of output optical fibres, comprising a wavelength division passive optical network demultiplexer.

According to an embodiment of the present invention there is provided an underwater hydrocarbon extraction facility communications system comprising the routing module according to the first aspect and a plurality of output optical fibres connected thereto.

According to an embodiment of the present invention there is provided a hydrocarbon extraction facility communications system comprising the underwater hydrocarbon extraction facility communications system according to the second aspect, further comprising a surface-located control station and an umbilical cable, the umbilical cable carrying an input optical fibre, the input optical fibre being operatively connected to the control station and the routing module, the control station being operable to wavelength division multiplex communications signals onto the input optical fibre.

According to an embodiment of the present invention there is provided a method for routing communications signals at an underwater hydrocarbon extraction facility, the method comprising the steps of:

i) providing a routing module at an underwater location, the routing module comprising a passive wavelength division demultiplexer,

ii) sending wavelength division multiplexed communications signals to the routing module from a surface location via an input optical fibre,

iii) demultiplexing said wavelength division multiplexed communications signals using the passive wavelength division demultiplexer to produce a plurality of demultiplexed output communications signals, and

iv) outputting the output demultiplexed communications signals via respective output optical fibres.

### BRIEF DESCRIPTION OF THE DRAWINGS

The invention will now be described with reference to the accompanying drawings, in which:

FIG. 1 schematically shows a known, active system for communications routing and distribution within a hydrocarbon extraction facility;

FIG. 2 schematically shows an enlarged view of the distribution unit of FIG. 1;

FIG. 3 schematically shows a passive system for communications routing and distribution within a hydrocarbon extraction facility in accordance with an embodiment of the present invention;

FIG. 4 schematically shows an enlarged view of the distribution unit of FIG. 1;

FIG. 5 schematically shows a network topology for a system in accordance with an embodiment of the present invention; and

FIG. 6 schematically shows a communications routing system enabling the use of separate transmit and receive optical converters in accordance with an embodiment of the present invention.

### DETAILED DESCRIPTION

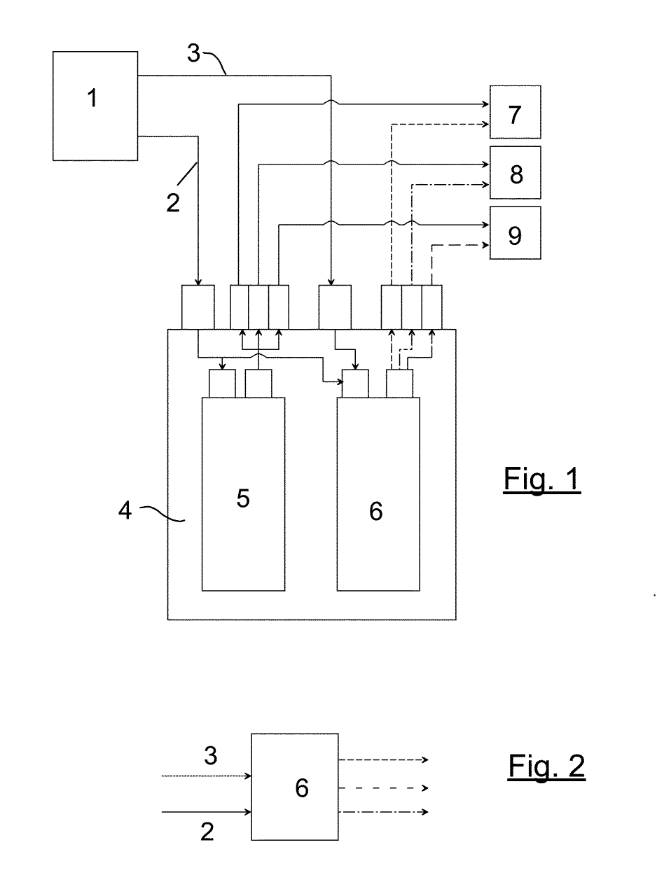

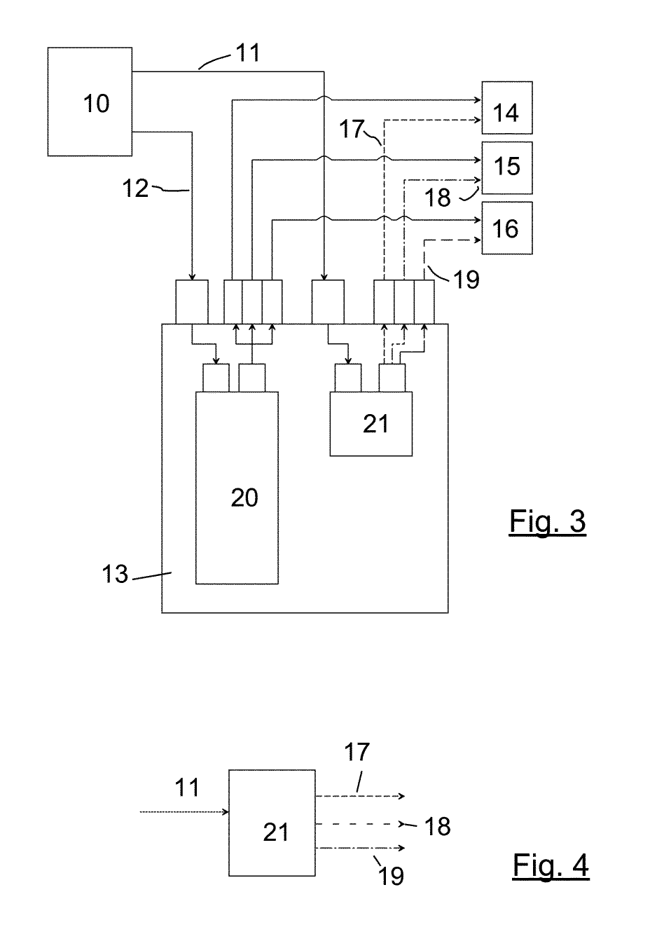

An embodiment of the present invention is schematically shown in FIGS. 3 and 4. It can be seen that the power and communications system has many similarities to the known system as shown in FIG. 1, for example, a topside master control station 10 provides power and communications signals to respective lines located within an umbilical cable (not shown), with the communications signals being carried by an input optical fibre 11 and the power being carried by a copper line 12. At the underwater end of the umbilical, the power and communications lines 11, 12 are received by a PCDM 13, configured for routing power and communications signals to respective control modules 14, 15, 16, the communications signal being sent by respective output optical fibres 17, 18, 19. However, PCDM 13 differs from that of FIG. 1. While PCDM 13 comprises a power distribution unit 20 for receiving power from the umbilical and distributing this to each of control modules 14-16, communications routing is achieved using passive technology—a passive wavelength division demultiplexer (“wavelength division passive optical network” or “WDPON” device) 21. As the component 21 is passive, no power tap is required for its operation. The demultiplexer 21 is shown in enlarged schematic form in FIG. 4.

Wavelength division methodology (as opposed to time division methods) as utilised by the embodiments of the present invention, allows for transmission of communications signals for equivalent lengths of a point-to-point connection (minus attenuation of the PON unit).

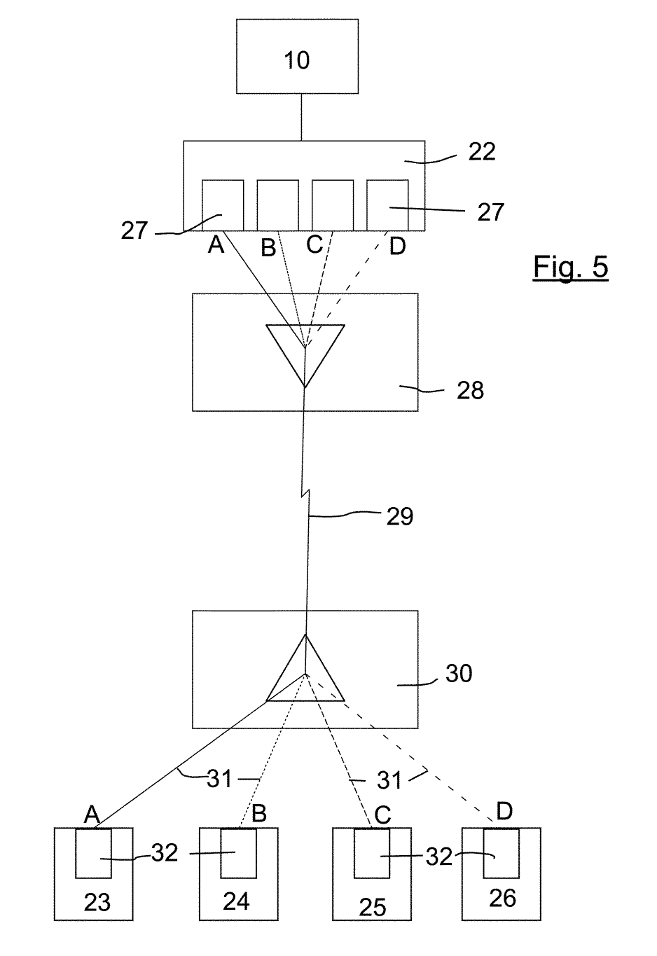

FIG. 5 schematically shows a network topology for the system similar to that of FIGS. 3 and 4, but here including four underwater control modules rather than three. In use, a signal originating from the master control station 10 is passed to a topside active master router 22, e.g. a Layer 3 Ethernet switch. The router 22 routes the signal to the correct communications channel, with four channels A-D being shown, each associated with a particular underwater control module 23-26. In other words, the “correct” channel is that channel for the intended control module. Each channel is attached to an optical media converter 27 tuned to a specific wavelength. Each optical media converter 27 is an optical transceiver, i.e. which converts from optical to electrical communication signals for interpretation by a separate microcontroller (not shown). The optical converter 27 transmits to a master wavelength division passive optical network (WDPON) device 28 which acts as a combiner with the other wavelength signals from sister optical media converters 27. This combined signal is transmitted down a single input optical fibre 29 located within an umbilical to an underwater-located end-point WDPON 30. This WDPON 30 splits the signal again into the separate wavelengths, which then route, via respective output optical fibres 31, to respective terminal optical media converters 32, located at respective control modules 23-26. Each optical media converter may comprise a small form-factor pluggable (SFP) device, more particularly an auto-tuning SFP.

The media converters 32 will need to “tune” to the correct wavelength when first deployed. If auto-tuning SFPs are used as the underwater media converters, the following methodology may be adopted to achieve this, which avoids the need for pre-programming:

i) Topside converters 27 are assigned to different respective channels, and set to actively “listen” on, i.e. to detect signals within that channel received from the underwater location;

ii) Each control module 23-26 scans the spectrum for active channels, and requests the channel numbers from each topside converter 27 until the assigned channel ID is detected; and

iii) The underwater converter 32 then locks onto this channel frequency for the duration of its operation.

It should be noted that this auto-tuning feature of SFPs is known per se, for example from US-A1-20130071108, WO-A1-2013152278, WO-A1-2013173616, US-A1-20130308951 and US-B2-8254793, and so the mechanism for auto-tuning is not discussed in detail here.

It should also be noted that the systems described so far are bi-directional, so that they may equally be used to send communications signals from individual underwater control modules to the surface.

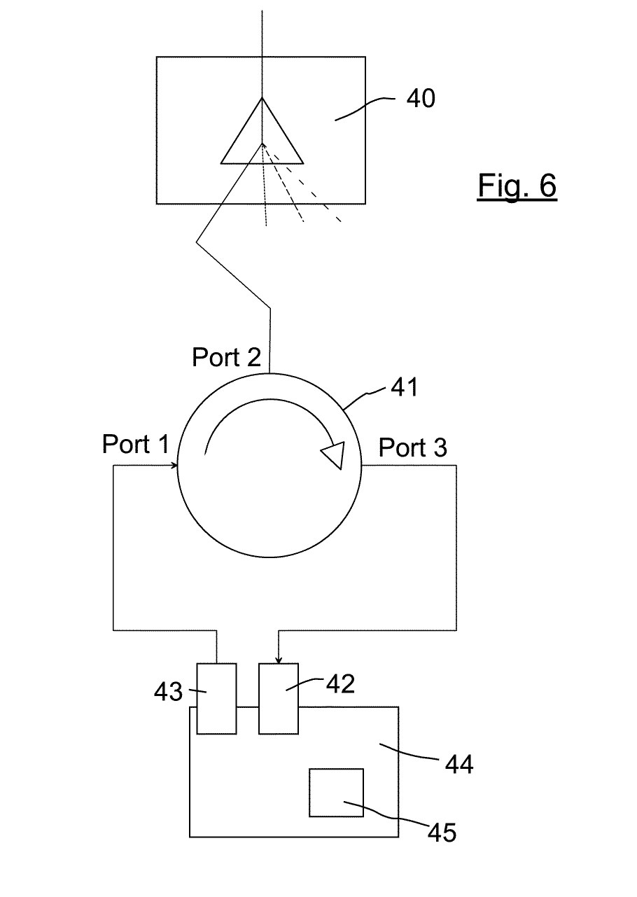

In the case where separate transmit and receive optical media converters are required per channel, optical circulator technology can be used to combine transmit (Tx) and receive (Rx) onto a single fibre. A suitable arrangement of routing system is shown in FIG. 6, where the topside components are omitted for clarity.

Similarly to the arrangement shown in FIG. 5, an underwater WDPON 40 is provided to receive multiplexed communications signals from the input optical fibre. Here though, in each output optical fibre where separate converters are required, an optical circulator 41 is provided. This is used to passively route a signal received at port 2 (i.e. from WDPON 40) to port 3. Port 3 is then connected to a receive optical media converter such as an SFP 42 located at the control module 44. A processing means 45 is also shown in control module 44. When the control module 44 is ready to transmit, it does so from a transmit optical media converter SFP 43. The optical circulator 41 takes this signal from the transmit SFP 43 at port 1 and passively routes it to port 2, and thus back to WDPON 40 and on to the rest of the system.

The above-described embodiments are exemplary only, and other possibilities and alternatives within the scope of the embodiments of the present invention will be apparent to those skilled in the art. For example, the system may be distributed, so that components may be located in different positions within the overall topology (e.g. optical converters shown as being located within underwater control modules may instead be located in an external module and connected to the control module by additional fibre). As another example, circulators may be provided within the PCDM, external to the PCDM, or within a respective control module. The numbers of control modules/channels may be freely selected as the facility architecture and requirements dictate. In some embodiments, passive optics may connect directly to valves (e.g. electric actuators) or other control devices. Additionally/alternatively, the optical signals may communicate as transparent channels to third party equipment (e.g. subsea sensors). While SFP devices have been indicated above as being particularly suitable, any tuneable optical transceiver may feasibly be used instead, or even an addressable wavelength modifier separate to the transceiver.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A routing module for an underwater hydrocarbon extraction facility, the routing module configured to receive a multiplexed communications signal via an input optical fibre and output demultiplexed communications signals to a plurality of output optical fibres, comprising a wavelength division passive optical network demultiplexer.

2. An underwater hydrocarbon extraction facility communications system, the system comprising:
a routing module and
a plurality of output optical fibres connected thereto.

3. The system according to claim 2, further comprising an optical media converter connected with each output optical fibre.

4. The system according to claim 3, wherein each optical media converter comprises an auto-tuning small form-factor pluggable device.

5. The system according to claim 2, wherein at least one output optical fibre is connected to an optical circulator.

6. The system according to according to claim 2, further comprising a plurality of control modules, and wherein each output optical fibre is operatively connected to a respective control module.

7. A hydrocarbon extraction facility communications system, the system comprising
the underwater hydrocarbon extraction facility communications system according to claim 2,
a surface-located control station and
an umbilical cable, the umbilical cable carrying an input optical fibre, the input optical fibre being operatively connected to the control station and the routing module, the control station being operable to wavelength division multiplex communications signals onto the input optical fibre.

8. A method for routing communications signals at an underwater hydrocarbon extraction facility, the method comprising the steps of:
providing a routing module at an underwater location, the routing module comprising a passive wavelength division demultiplexer;
sending wavelength division multiplexed communications signals to the routing module from a surface location via an input optical fibre; demultiplexing said wavelength division multiplexed communications signals using the passive wavelength division demultiplexer to produce a plurality of demultiplexed output communications signals; and
outputting the output demultiplexed communications signals via respective output optical fibres.

9. The method according to claim 8, further comprising the step of providing an optical media converter connected to each output optical fibre.

10. The method according to claim 9, wherein each optical media converter comprises an auto-tuning small form-factor pluggable device.

11. The method according to claim 10, further comprising the step of tuning each small form-factor pluggable device to a communications channel of interest.

12. The method according to claim 8, further comprising the step of providing an optical circulator connected to each output optical fibre.
